(19) United States
(12) Patent Application Publication
(10) Pub. No.: US 2005/0049733 A1
(43) Pub. Date: Mar. 3, 2005

(54) Dual-use audio signal player for analogue record and digital CD

(76) Inventors: Chiu-Hsiung Liu, Tainan (TW); Chin-Chen Ho, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,116

(22) Filed: Sep. 3, 2003

(51) Int. Cl. G06F 17/00

(52) U.S. Cl. 700/94

(57) ABSTRACT

A dual-use audio signal player includes a first turntable for a CD to be loaded thereon, a processing circuit, a second turntable, and a shank for connection with a pick-up to be used with the second turntable; the shank is connected to the processing circuit; an analogue record can be manually turned at various speeds and in selected directions to accordingly change the way the analogue record is played for special effects when the record is loaded on the second turntable; audio signals of the CD on the first turntable, after having been stored in a dynamic random access memory, can be played for special effects according to the way an especially made digital record is manually turned when the especially made digital record is loaded on the second turntable instead of the analogue record, and when a digital pick-up is connected to the shank instead of an original analogue pick-up.

### BACKGROUND OF THE INVENTION

1. Field of the Invention

The present invention relates to a dual-use audio signal player for analogue record and digital CD, which includes a first turntable having an audio compact disk loaded thereon, and a second turntable such that an analogue record can be manually turned at various speeds and in selected directions to accordingly change the way music is played for special effects when the analogue record is loaded on the second turntable, and when an analogue pick-up is used on the analogue record, and such that audio signals of the audio compact disk, after having been stored in a dynamic random access memory, can be played for special effects according to the way an especially made digital record is manually turned when the digital record is loaded on the second turntable instead of the analogue record, and when a digital pick-up is used on the digital record instead of the analogue pick-up.

2. Brief Description of the Prior Art

In order to help increase hot and exciting atmosphere in a concert or a party such as is held in a PUB or a dancing hall, the DJ usually makes the music played with changing tone and speed by means of moving the analogue record loaded on the turntable manually at various speeds and in selected directions. When the DJ stops moving the record with his hands, the record will be played on the record player in the normal way immediately.

However, a single analogue record has very limited capacity for storing music. Consequently, the DJ has to prepare a lot of analogue records in each party, and the records are likely to the DJ inconvenience due to the large size and heavy weight.

In order to overcome the above disadvantages, the inventor of the present invention devised a digital audio signal player having a simulated analogue record such that audio signals of an audio compact disk loaded on the turntable, after having been stored in a dynamic random access memory, can be played for special effects according to the way a rotary control element is manually turned by the DJ. Therefore, music can be played at various speeds and in selected directions by means of rotating the rotary control element with the DJ's hand, and can be played in the normal way as soon as the DJ stops turning the rotary control element manually. Because audio compact disks are lighter in weight and smaller in size than conventional records, they are easier to prepare, and it is more convenient to use this digital audio signal player having a simulated analogue record.

However, this digital audio signal player having a simulated analogue record is found to have a disadvantage; because a conventional analogue record is normally turned together with a turntable, on which it is loaded, when it is being played, and will be stopped from turning together with the turntable while when the DJ presses the record against the turntable, the DJ can make music stop by means of holding the record still when a conventional record player is used, but he can't make music stop by means of controlling the rotary control element when the digital audio signal player having a simulated analogue record is used because when music is being played, the rotary control element is normally still, not like a conventional analogue record. Consequently, the DJ can only change the way music is played, but he can't make the music stop by means of operating the rotary control element.

Moreover, many DJs still prefer using analogue records in spite of the convenience of digital CDs because they are more familiar with the touch of analogue records, which is much different from that of the rotary control element. Consequently, the digital audio signal player having a simulated analogue record still can't take the place of conventional record players.

### SUMMARY OF THE INVENTION

It is a main object of the present invention to provide an audio signal player, which can be made to produce special effects of music of a CD by means of operating an especially made digital record that will feel similar to a conventional analogue record when being operated on the turntable, and which can be used to play a conventional analogue record that is loaded on the turntable instead of the especially made digital record.

The audio signal player of the present invention includes a first turntable for a CD to be loaded thereon, a digital/analogue signal switching and processing circuit, a second turntable, and a shank for connection with a pick-up to be used with the second turntable; the shank is connected to the digital/analogue signal switching and processing circuit, and has to be connected to a digital pick-up when especially made digital record is loaded on the second turntable, which digital record is formed with circular guiding rails concentric with it, and being printed with digital lines between the circular guiding rails. Audio signals of the CD loaded on the first turntable, after having been stored in a dynamic random access memory, can be played for special effects according to the way the especially made digital record is manually turned after the especially made digital record has been loaded on the second turntable, and after the digital pick-up is connected to the shank.

### BRIEF DESCRIPTION OF THE DRAWINGS

This invention will be better understood by referring to the accompanying drawings, wherein:

FIG. 1 is a block diagram of the circuit of the dual-use audio signal player according to the present invention,

FIG. 2 is a vertical view of the digital record for the dual-use audio signal player of the present invention,

FIG. 3 is a partial side view of the digital record for the dual-use audio signal player of the present invention,

FIG. 4 is a view of a digital pick-up and an analogue pick-up for the dual-use audio signal player of the present invention, and

FIG. 5 is a view showing the relationship of the digital pick-up and the analogue pick-up with the shank according to the present invention.

### DETAILED DESCRIPTION OF THE PREFERRED EMBODIMENTS

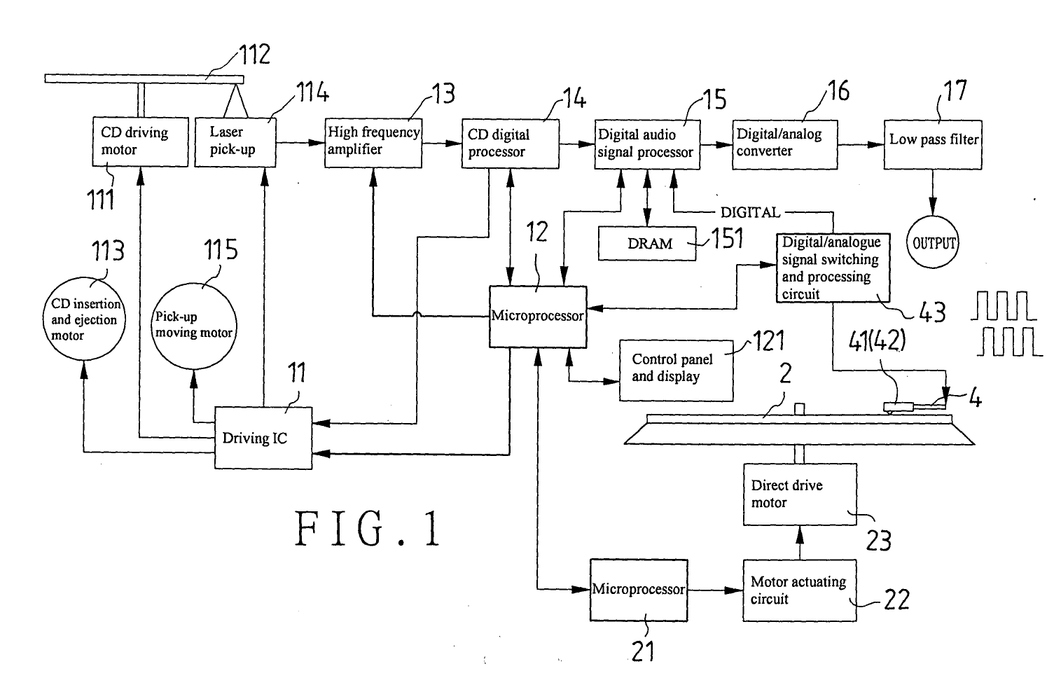

Referring to FIG. 1, a preferred embodiment of a dual-use audio signal player in the present invention includes a driving IC 11, a CD driving motor 111, a first turntable 112, a CD insertion and ejection motor 113, a laser pick-up 114, a pick-up moving motor 115, a microprocessor 12, a control panel and display 121, a high frequency amplifier 13, a CD digital processor 14, a digital audio signal processor 15, a dynamic random access memory (DRAM) 151, a digital/analog converter 16, and a low pass filter 17.

The turntable 112 is provided for an analogue CD to be loaded thereon, and electrically connected to the CD driving motor 111. The driving IC 11 is connected to the CD driving motor 111, and the CD insertion and ejection motor 113 for activating both, which are provided respectively for turning the turntable 112, and for linearly displacing a CD loaded on the turntable 112.

When the microprocessor 12 is activated, it will make the high frequency amplifier 13 send out laser light, and activate the laser pick-up 114 by means of both the CD digital processor 14 and the driving IC 11. The driving IC 11 will also activate the pick-up moving motor 115 to move the laser pick-up 114. The laser pick-up 114 will send signals to the CD digital processor 14 via the high frequency amplifier 13. And, when the CD driving motor 111 is activated, it will make the turntable 112 rotate at two times a normal speed such that a CD positioned loaded on the turntable 112 is rotated accordingly. Thus, the laser pick-up 114 will read the data of the CD, and send the data to both the microprocessor 12 and the digital audio signal processor 15 via the high frequency amplifier 13 and the CD digital processor 14 while information about the CD is shown on the displaying portion of the control panel and display 121. And, the data of the CD will be stored in the dynamic random access memory 151, and the data in the dynamic random access memory 151 will be sent to the digital audio signal processor 15, and converted into analogue ones by means of the digital/analog converter 16 when the CD is to be played. Finally, the analogue data are processed by the low pass filter 17, and output as music.

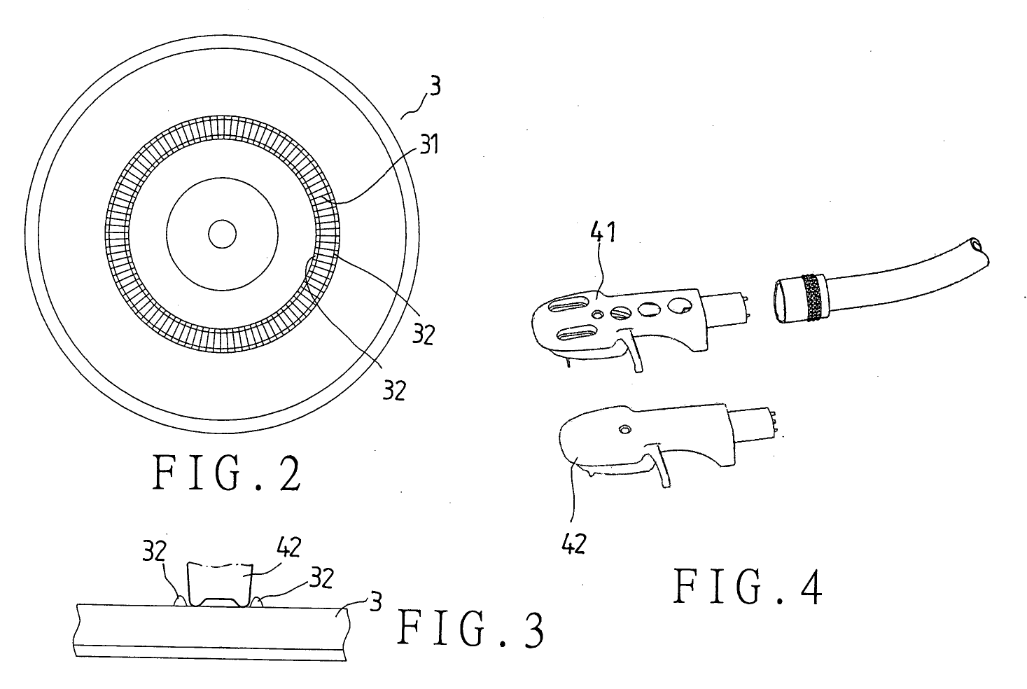

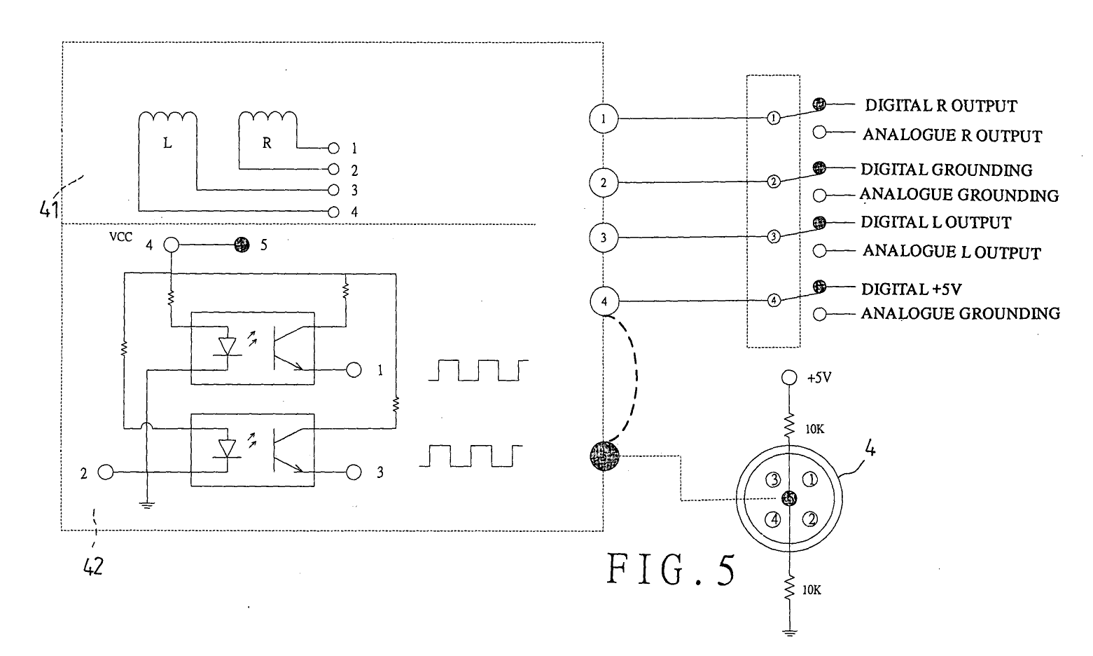

All of the above devices and structure are the same as those of the prior digital audio signal player having a simulated analogue record, which was also devised by the inventor of the present invention. And, referring to FIGS. 1 to 5, the dual-use audio signal player of the present invention is further provided with a second turntable 2, a microprocessor 21 of a control system for the second turntable 2, a motor actuating circuit 22, a direct drive motor 23, a shank 4 having five terminals, and a digital/analogue signal switching and processing circuit 43.

The microprocessor 21 is electrically connected to the motor actuating circuit 22 for controlling the circuit 22. The direct drive motor 23 is electrically connected to both the second turntable 2 and the motor actuating circuit 22 so that the turntable 2 can be actuated, stopped, and changed in the speed of rotation. The digital/analogue signal switching and processing circuit 43 is electrically connected to both the shank 4 and the digital audio signal processor 15. The second turntable 2 can be loaded with an analogue record or an especially made digital record 3, which is formed with circular guiding rails 32 concentric with it, and is printed with digital lines 31 between the circular guiding rails 32. Because the especially made digital record 3 is also to be loaded on the turntable 2, it will feel similar to an analogue record when being manually operated.

When the second turntable 2 is loaded with an analogue record, the shank 4 has to be connected with an analogue pick-up 41, which has four terminals, such that a fifth terminal of the shank 4 has a voltage of about 2.5 V, and in turns, the digital/analogue signal switching and processing circuit 43 will switch to an analogue output mode automatically. When the second turntable 2 is loaded with the especially made digital record 3 instead of the analogue record, the shank 4 has to be connected with a digital pick-up 42 instead of the analogue pick-up 41, which has five terminals, such that fourth and fifth terminals of the digital pick-up 42 are shorted, and the fifth terminal of the shank 4 has a voltage of either one of 0 V and 5 V, and in turns, the digital/analogue signal switching and processing circuit 43 will switch to a digital output mode automatically.

Thus, when the second turntable 2 is loaded with a conventional analogue record, and when the analogue pick-up 41 is connected with the shank 4, the analogue record can be manually turned at various speeds and in selected directions to make music played accordingly for special audio effects. And, when the second turntable 2 is loaded with the especially made digital record 3 instead, and when the digital pick-up 42 is connected to the shank 4 instead, the especially made digital record 3 can be manually turned at various speeds and in selected directions to accordingly change the way the data of a CD are played, which have been stored in the DRAM 151, for special audio effects; the digital pick-up 42 will receive two signals that have a phase difference of ninety degrees from the digital lines 31 by means of light reflection such that the speed and direction of rotation of the especially made digital record 3 can be calculated based on the length of time between the two signals and time order of the two signals respectively.

From the above description, it can be easily understood that the present audio signal player has an advantage over the prior one; the second turntable 2 can be loaded with a conventional analogue record for the DJ to turn manually for producing special audio effects, and can be loaded with the especially made digital record 3 instead. Consequently, the present audio signal player will be accepted by DJs and other people because the especially made digital record can be stopped for stopping music like an analogue record, and will feel similar to an analogue record when being manually operated on the turntable 2.

1. A dual-use audio signal player, comprising
a first turntable provided for a CD to be loaded thereon;
a driving IC;
a microprocessor;
a high frequency amplifier, the high frequency amplifier being electrically connected to the microprocessor for sending out laser light when activated by the microprocessor;
a CD digital processor electrically connected to both the microprocessor and the high frequency amplifier;
a laser pick-up electrically connected to the high frequency amplifier for reading data of a CD loaded on the first turntable, and sending the data to the CD digital processor;
a CD driving motor electrically connected with the driving IC; the CD driving motor rotating the first turntable at twice a normal speed when activated;
a digital audio signal processor electrically connected to both the microprocessor and the CD digital processor; the data of a CD being sent to the digital audio signal processor and stored in a DRAM after having been sent to the CD digital processor;
a digital/analogue converter electrically connected to the digital audio signal processor for converting the data of a CD into analogue ones;
a low pass filter connected to the digital/analogue converter for processing the analogue data before the data are output as music;
the audio signal player being further provided with a second turntable, and a second microprocessor connected to the second turntable; the second microprocessor being connected to a motor actuating circuit; a direct drive motor being connected with both the motor actuating circuit and the second turntable such that the second turntable can be actuated, stopped, and changed in rotational speed by means of the second microprocessor, the motor actuating circuit, and the direct drive motor;
the second turntable being capable of being loaded with a digital record; the digital record being formed with circular guiding rails concentric with it, and being printed with digital lines between the circular guiding rails;
a digital/analogue signal switching and processing circuit electrically connected to both a shank and the digital audio signal processor; the shank having five terminals; when the digital record is loaded on the second turntable, and when the shank is connected with a five-terminal digital pick-up for use with the digital record, fourth and fifth terminals of the digital pick-up being shorted together for a fifth terminal of the shank to have a voltage of either one of 0 V and 5 V such that the digital/analogue signal switching and processing circuit will switch to a digital output mode automatically, and such that the digital record can be manually turned at various speeds and in selected directions for making the data in the DRAM to be played accordingly;
when an analogue record is loaded on the second turntable instead of the digital record, and when the shank is connected with a four-terminal analogue pick-up instead of the digital pick-up, the fifth terminal of the shank having a voltage of about 2.5 V such that the digital/analogue signal switching and processing circuit will switch to an analogue output mode automatically, and such that the analogue record can be manually turned at various speeds and in selected directions, and played accordingly.
